(19) United States
(12) Patent Application Publication
(10) Pub. No.: US 2026/0267590 A1
(43) Pub. Date: Sep. 10, 2026

(54) Focused Volume Control of Characters in a Stream

(71) Applicant: Comcast Cable Communications, LLC, Philadelphia, PA (US)

(72) Inventor: Ganesh Narayanan, Chennai (IN)

(21) Appl. No.: 19/069,303

(22) Filed: Mar. 4, 2025

(51) Int. Cl. G06F 3/16; H04N 21/439; H04N 21/485

(52) U.S. Cl. CPC G06F 3/165; H04N 21/4396; H04N 21/4852

(57) ABSTRACT

Systems, apparatuses, and methods are described for volume control of individual characters in a video stream. Audio signals of individual characters and/or objects may be separately controlled (e.g., suppressed, muted, amplified, translated, etc.), for example, based on instructions from a user. The user may manually select one or more characters via an interface for the audio signal control. Also or alternatively, audio signals may be automatically adjusted based on actions, words, and/or environment of the user. Customized soundtracks may be dynamically created by and/or for different users, and/or may be shared as special sound modes for different groups of people (e.g., hearing-impaired people).

### BACKGROUND

A video such as a live stream or a video-on-demand (VOD) stream may be output on a multi-media device (e.g., television, video player, computer, etc.). Volume (or sound) of the video may be increased, decreased, or muted. A user may increase the overall volume of the video, for example, if he or she cannot hear the voice of a character clearly. A user may decrease the overall volume or even mute the video, for example, if he or she or other people are bothered by the sound. However, improvements are needed to allow a better user experience, to allow a user to control volume levels of individual sounds or characters in the video. These and other shortcomings are identified and addressed in the disclosure.

### SUMMARY

The following summary presents a simplified summary of certain features. The summary is not an extensive overview and is not intended to identify key or critical elements.

Systems, apparatuses, and methods are described for volume control of individual characters, or other sound sources, in a video stream. Audio signals (such as voices of individual characters) in a video may be separated and/or mapped to corresponding characters or sound sources (e.g., machine or nature sounds) in the video frames. Audio signals of a specific character may be changed (e.g., suppressed, muted, amplified, translated, etc.), for example, based on input from a user. The user may manually select one or more characters or sound sources, via an interface, to control audio characteristics associated with their voices. The interface may be presented and displayed on a device that is playing the video and/or on a separate control device. Additionally or alternatively, audio signals may be automatically adjusted based on analysis on behaviors, words, and/or environment of the user. Similarly, audio signals (or sounds) of individual objects (e.g., a jet engine, etc.) may be separately controlled. Customized soundtracks may be dynamically created by and/or for different users and/or may be shared as special sound modes for different groups of people (e.g., hearing-impaired people). Improvements such as increased flexibility, enhanced user experience, etc. may be achieved.

These and other features and advantages are described in greater detail below.

### BRIEF DESCRIPTION OF THE DRAWINGS

Some features are shown by way of example, and not by limitation, in the accompanying drawings. In the drawings, like numerals reference similar elements.

FIG. 1 shows an example communication network.

FIG. 2 shows hardware elements of a computing device.

FIGS. 3A, 3B, 3C, 3D, 3E, 3F, 3G, 3H, 3I, 3J, 3K, and 3L show example interfaces for character and/or object audio control.

FIG. 4A shows an example application of manually selecting a character for audio control.

FIG. 4B shows another example interface for manual selection for audio control.

FIG. 4C shows an example interface for realizing language translation for a person.

FIG. 5 is a block diagram showing functional components associated with focused volume control.

FIG. 6A shows an example of mixed audio signals and separated audio signals.

FIG. 6B shows an example of separating mixed audio signals into individual audio signals.

FIG. 6C shows examples of separating mixed audio signals of a frame into individual audio signals.

FIG. 6D shows examples of amplifying, de-amplifying, and muting an individual soundtrack.

FIG. 7 is a block diagram showing circuit elements for amplifying, de-amplifying, and muting an individual soundtrack.

FIG. 8A shows an example interface for general volume control and audio modes.

FIG. 8B shows an example interface for custom audio modes.

FIGS. 9A and 9B are a flow chart showing an example method for focused volume control for a video.

### DETAILED DESCRIPTION

The accompanying drawings, which form a part hereof, show examples of the disclosure. It is to be understood that the examples shown in the drawings and/or discussed herein are non-exclusive and that there are other examples of how the disclosure may be practiced.

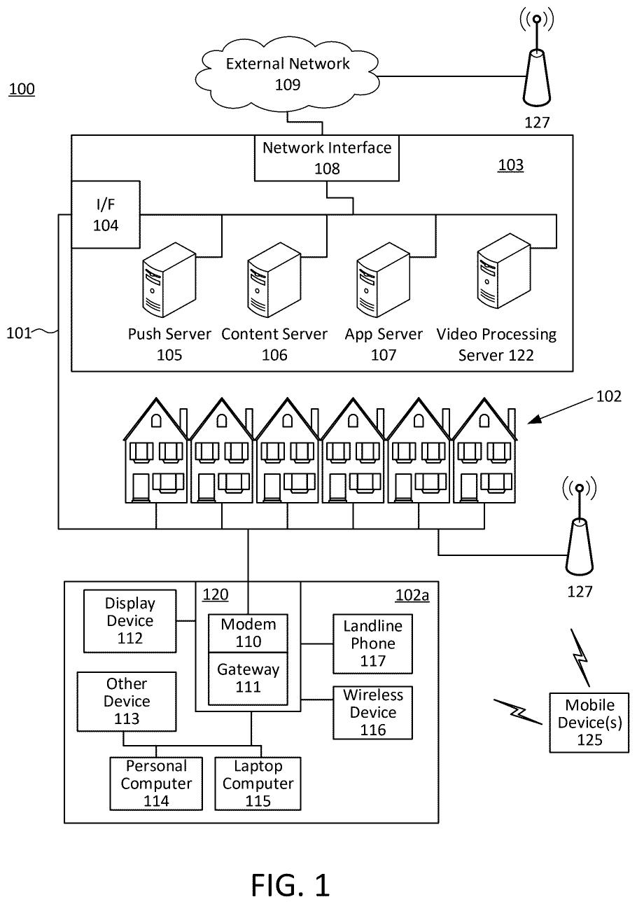

FIG. 1 shows an example communication network 100 in which features described herein may be implemented. The communication network 100 may comprise one or more information distribution networks of any type, such as, without limitation, a telephone network, a wireless network (e.g., an LTE network, a 5G network, a WiFi IEEE 802.11 network, a WiMAX network, a satellite network, and/or any other network for wireless communication), an optical fiber network, a coaxial cable network, and/or a hybrid fiber/coax distribution network. The communication network 100 may use a series of interconnected communication links 101 (e.g., coaxial cables, optical fibers, wireless links, etc.) to connect multiple premises 102 (e.g., businesses, homes, consumer dwellings, train stations, airports, etc.) to a local office 103 (e.g., a headend). The local office 103 may send downstream information signals and receive upstream information signals via the communication links 101. Each of the premises 102 may comprise devices, described below, to receive, send, and/or otherwise process those signals and information contained therein.

The communication links 101 may originate from the local office 103 and may comprise components not shown, such as splitters, filters, amplifiers, etc., to help convey signals clearly. The communication links 101 may be coupled to one or more wireless access points 127 configured to communicate with one or more mobile devices 125 via one or more wireless networks. The mobile devices 125 may comprise smart phones, tablets or laptop computers with wireless transceivers, tablets or laptop computers communicatively coupled to other devices with wireless transceivers, and/or any other type of device configured to communicate via a wireless network.

The local office 103 may comprise an interface 104. The interface 104 may comprise one or more computing devices configured to send information downstream to, and to receive information upstream from, devices communicating with the local office 103 via the communications links 101. The interface 104 may be configured to manage communications among those devices, to manage communications between those devices and backend devices such as servers 105-107 and 122, and/or to manage communications between those devices and one or more external networks 109. The interface 104 may, for example, comprise one or more routers, one or more base stations, one or more optical line terminals (OLTs), one or more termination systems (e.g., a modular cable modem termination system (M-CMTS) or an integrated cable modem termination system (I-CMTS)), one or more digital subscriber line access modules (DSLAMs), and/or any other computing device(s). The local office 103 may comprise one or more network interfaces 108 that comprise circuitry needed to communicate via the external networks 109. The external networks 109 may comprise networks of Internet devices, telephone networks, wireless networks, wired networks, fiber optic networks, and/or any other desired network. The local office 103 may also or alternatively communicate with the mobile devices 125 via the interface 108 and one or more of the external networks 109, e.g., via one or more of the wireless access points 127.

The push notification server 105 may be configured to generate push notifications to deliver information to devices in the premises 102 and/or to the mobile devices 125. The content server 106 may be configured to provide content to devices in the premises 102 and/or to the mobile devices 125. This content may comprise, for example, video, audio, text, web pages, images, files, etc. The content server 106 (or, alternatively, an authentication server) may comprise software to validate user identities and entitlements, to locate and retrieve requested content, and/or to initiate delivery (e.g., streaming) of the content. The application server 107 may be configured to offer any desired service. For example, an application server may be responsible for collecting, and generating a download of, information for electronic program guide listings. Another application server may be responsible for monitoring user viewing habits and collecting information from that monitoring for use in selecting advertisements. Yet another application server may be responsible for formatting and inserting advertisements in a video stream being transmitted to devices in the premises 102 and/or to the mobile devices 125. The local office 103 may comprise additional servers, such as the video processing server 122 (described below), additional push, content, and/or application servers, and/or other types of servers. The video processing server 122 may be configured to process videos to be played, for example, on a display device 112 in a premises 102a. The video processing server 122 may separate a mixed audio track of a video (or video stream) into individual audio tracks, each individual audio track corresponding to a character or an object in the video. The video processing server 122 may connect (e.g., map) the individual audio tracks with corresponding characters and/or objects in video frames, for example, by generating metadata associated with the video frames and the audio tracks. Such a character or object may generate (or appear to generate) sound (alternately referred to herein as audio) and may thus be referred to herein as a sound source (or alternatively, an audio source). A character or object may appear to generate sound if, for example, sound corresponding to that character or object in an audio track actually came from some other source but is made to appear (e.g., by dubbing) as though it came from that character or object.

The video processing server 122 may process one or more individual audio tracks to change (e.g., amplify, de-amplify, mute, etc.) the one or more audio tracks, for example, based on control signals generated based on manual selection and/or automatic determination. Alternatively or additionally, the video processing server 122 may replace one or more individual audio tracks with one or more other audio tracks. The video processing server 122 may combine the changed and/or replaced audio track(s) and corresponding video frames to generate an updated video. The video processing server 122 may save the updated video and/or audio track(s), for example, for repeated use and/or sharing. Although shown separately, the push server 105, the content server 106, the application server 107, the video processing server 122, and/or other server(s) may be combined. The servers 105, 106, 107, and 122, and/or other servers, may be computing devices and may comprise memory storing data and also storing computer executable instructions that, when executed by one or more processors, cause the server(s) to perform steps described herein. Also or alternatively, one or more of servers 105, 106, 107, and 122, and/or other servers, may be part of the external network 109 and may be configured to communicate (e.g., via the local office 103) with computing devices located in or otherwise associated with one or more premises 102.

An example premises 102a may comprise an interface 120. The interface 120 may comprise circuitry used to communicate via the communication links 101. The interface 120 may comprise a modem 110, which may comprise transmitters and receivers used to communicate via the communication links 101 with the local office 103. The modem 110 may comprise, for example, a coaxial cable modem (for coaxial cable lines of the communication links 101), a fiber interface node (for fiber optic lines of the communication links 101), twisted-pair telephone modem, a wireless transceiver, and/or any other desired modem device. One modem is shown in FIG. 1, but a plurality of modems operating in parallel may be implemented within the interface 120. The interface 120 may comprise a gateway 111. The modem 110 may be connected to, or be a part of, the gateway 111. The gateway 111 may be a computing device that communicates with the modem(s) 110 to allow one or more other devices in the premises 102a to communicate with the local office 103 and/or with other devices beyond the local office 103 (e.g., via the local office 103 and the external network(s) 109). The gateway 111 may comprise a set-top box (STB), digital video recorder (DVR), a digital transport adapter (DTA), a computer server, and/or any other desired computing device.

The gateway 111 may also comprise one or more local network interfaces to communicate, via one or more local networks, with devices in the premises 102a. Such devices may comprise, e.g., display devices 112 (e.g., televisions), other devices 113 (e.g., a DVR or STB), personal computers 114, laptop computers 115, wireless devices 116 (e.g., wireless routers, wireless laptops, notebooks, tablets and netbooks, cordless phones (e.g., Digital Enhanced Cordless Telephone—DECT phones), mobile phones, mobile televisions, personal digital assistants (PDA)), landline phones 117 (e.g., Voice over Internet Protocol—VoIP phones), and any other desired devices. Example types of local networks comprise Multimedia Over Coax Alliance (MoCA) networks, Ethernet networks, networks communicating via Universal Serial Bus (USB) interfaces, wireless networks (e.g., IEEE 802.11, IEEE 802.15, Bluetooth), networks communicating via in-premises power lines, and others. The lines connecting the interface 120 with the other devices in the premises 102a may represent wired or wireless connections, as may be appropriate for the type of local network used. One or more of the devices at the premises 102a may be configured to provide wireless communications channels (e.g., IEEE 802.11 channels) to communicate with one or more of the mobile devices 125, which may be on-or off-premises.

The mobile devices 125, one or more of the devices in the premises 102a, and/or other devices may receive, store, output, and/or otherwise use assets. An asset may comprise a video, a game, one or more images, software, audio, text, webpage(s), and/or other content.

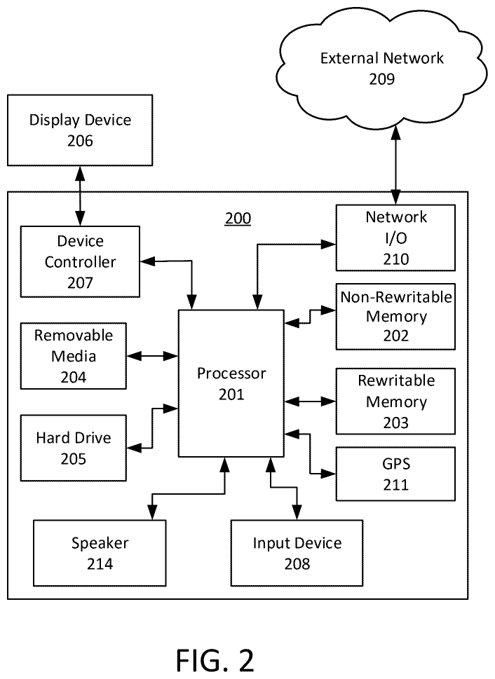

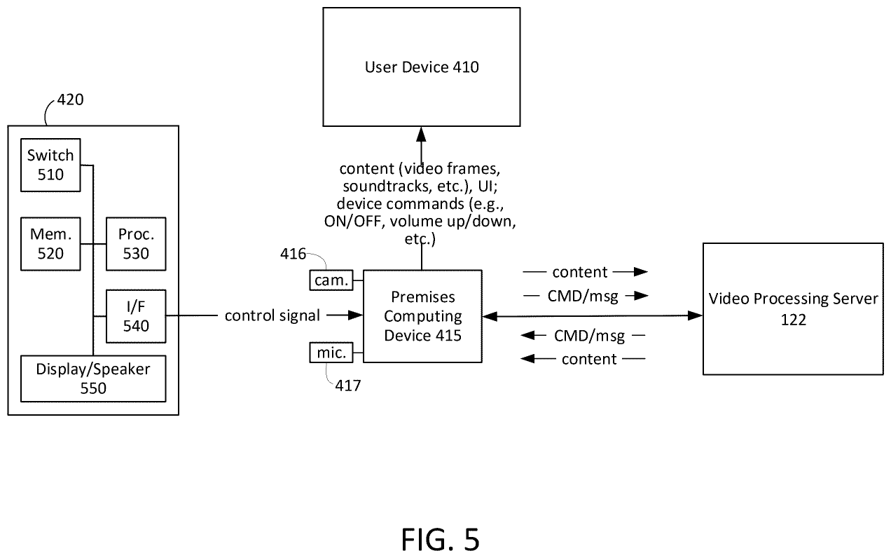

FIG. 2 shows hardware elements of a computing device 200 that may be used to implement any of the computing devices shown in FIG. 1 (e.g., the mobile devices 125, any of the devices shown in the premises 102a, any of the devices shown in the local office 103, any of the wireless access points 127, any devices with the external network 109) and any other computing devices discussed herein (e.g., the video processing server 122, a premises computing device 415 as shown in FIG. 5). The computing device 200 may comprise one or more processors 201, which may execute instructions of a computer program to perform any of the functions described herein. The instructions may be stored in a non-rewritable memory 202 such as a read-only memory (ROM), a rewritable memory 203 such as random access memory (RAM) and/or flash memory, removable media 204 (e.g., a USB drive, a compact disk (CD), a digital versatile disk (DVD)), and/or in any other type of computer-readable storage medium or memory. Instructions may also be stored in an attached (or internal) hard drive 205 or other types of storage media. The computing device 200 may comprise one or more output devices, such as a display device 206 (e.g., an external television and/or other external or internal display device) and a speaker 214, and may comprise one or more output device controllers 207, such as a video processor or a controller for an infra-red or BLUETOOTH transceiver. One or more user input devices 208 may comprise a remote control, a keyboard, a mouse, a touch screen (which may be integrated with the display device 206), microphone, etc. The computing device 200 may also comprise one or more network interfaces, such as a network input/output (I/O) interface 210 (e.g., a network card) to communicate with an external network 209. The network I/O interface 210 may be a wired interface (e.g., electrical, RF (via coax), optical (via fiber)), a wireless interface, or a combination of the two. The network I/O interface 210 may comprise a modem configured to communicate via the external network 209. The external network 209 may comprise the communication links 101 discussed above, the external network 109, an in-home network, a network provider's wireless, coaxial, fiber, or hybrid fiber/coaxial distribution system (e.g., a DOCSIS network), or any other desired network. The computing device 200 may comprise a location-detecting device, such as a global positioning system (GPS) microprocessor 211, which may be configured to receive and process global positioning signals and determine, with possible assistance from an external server and antenna, a geographic position of the computing device 200.

Although FIG. 2 shows an example hardware configuration, one or more of the elements of the computing device 200 may be implemented as software or a combination of hardware and software. Modifications may be made to add, remove, combine, divide, etc. components of the computing device 200. Additionally, the elements shown in FIG. 2 may be implemented using basic computing devices and components that have been configured to perform operations such as are described herein. For example, a memory of the computing device 200 may store computer-executable instructions that, when executed by the processor 201 and/or one or more other processors of the computing device 200, cause the computing device 200 to perform one, some, or all of the operations described herein. Such memory and processor(s) may also or alternatively be implemented through one or more Integrated Circuits (ICs). An IC may be, for example, a microprocessor that accesses programming instructions or other data stored in a ROM and/or hardwired into the IC. For example, an IC may comprise an Application Specific Integrated Circuit (ASIC) having gates and/or other logic dedicated to the calculations and other operations described herein. An IC may perform some operations based on execution of programming instructions read from ROM or RAM, with other operations hardwired into gates or other logic. Further, an IC may be configured to output image data to a display buffer.

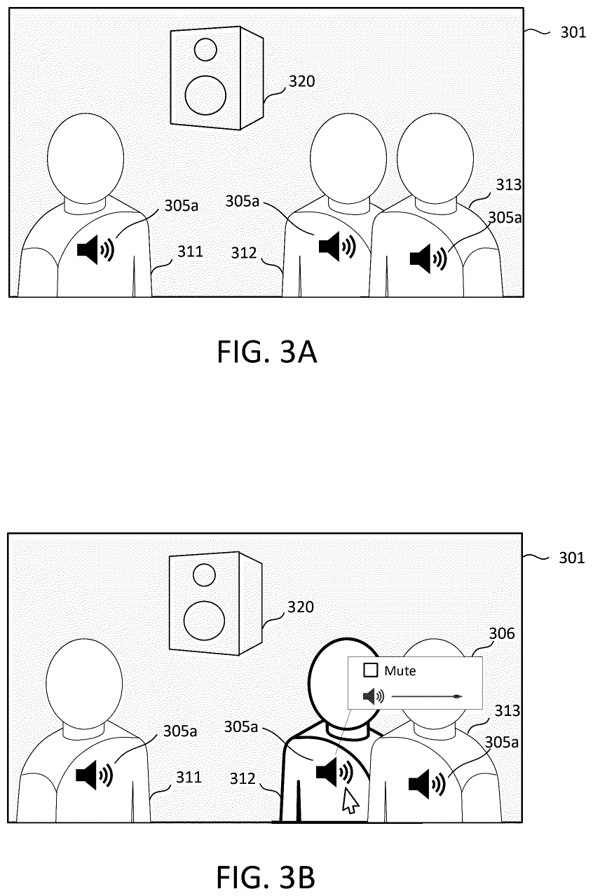

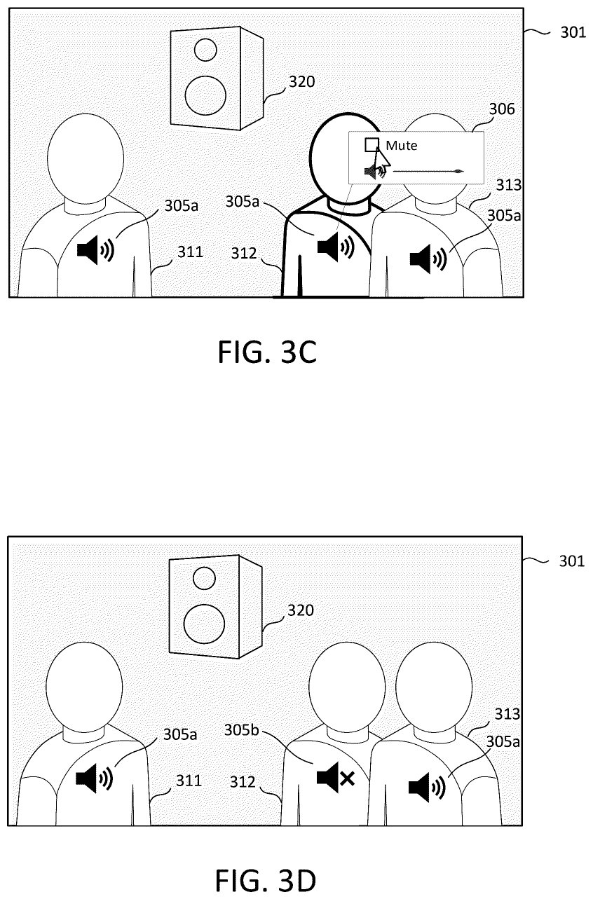

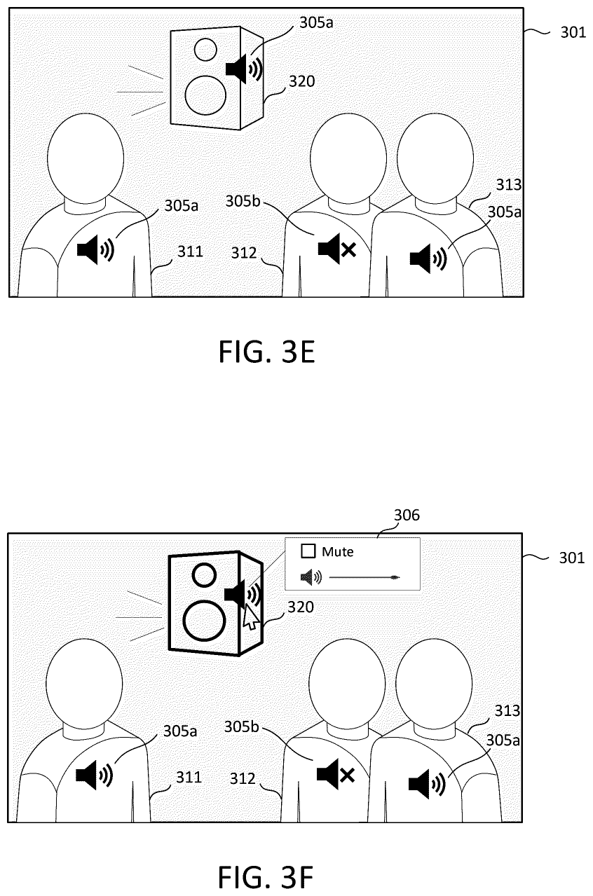

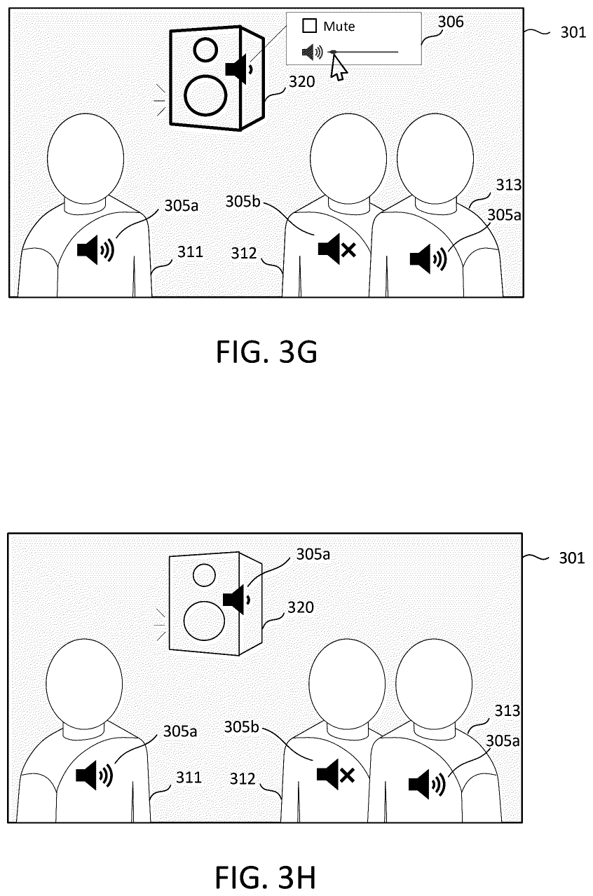

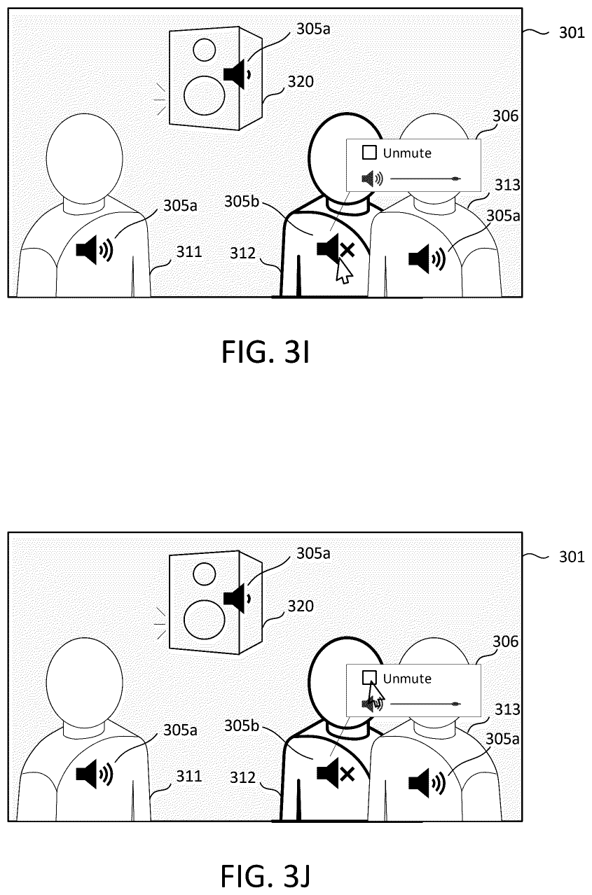

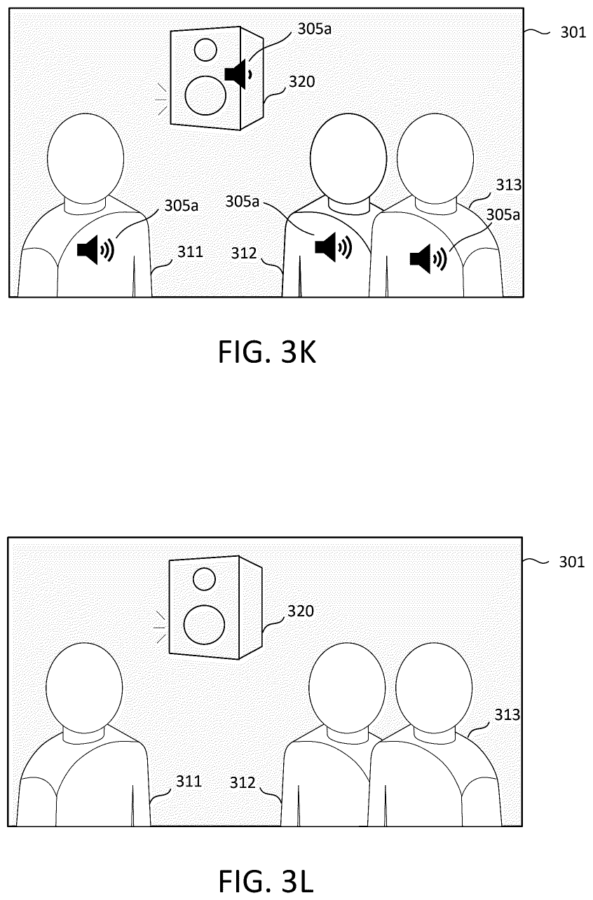

Videos played on a display device (e.g., display device 112) may have more than one character or object. Audio signals (e.g., volumes) of an individual character or object may be controlled manually and/or automatically. FIGS. 3A-3L show example interfaces for manual selection of a character and/or an object for audio control. More specifically, FIGS. 3A-3L shows an example set (e.g., series, sequence) of operations associated with audio control for a video display. The video display may be display of a live stream or a VOD stream of a video on a screen 301. The video may be, for example, a movie, a television (TV) show, an educational course, a promotional video, a sports program, a recorded art performance, a recorded gameplay, a recorded interview, a virtual tour, etc. In the example of FIGS. 3A-3L, there may be people (e.g., three people) and/or objects (e.g., a loudspeaker) that may generate sounds. For example, there may be a first person 311 (e.g., Joe), a second person 312 (e.g., Maria), and a third person 313 (e.g., Drew). These people may be having a conversation, a chat, a discussion, a debate, or any other talk. Alternatively or additionally, these people may be singing together, or making any other sounds. One, more than one (e.g., two), or all (e.g., three) of the people may be generating sounds (talking, singing, screaming, etc.) at a time (e.g., solo, simultaneously, or overlapping). There may be fewer people or more people. There may be any number/quantity of people. Alternatively or additionally, there may be an object 320 that is capable of generating sounds. The object may be, for example, a loudspeaker (e.g., a stereo speaker), a musical instrument (e.g., a piano), a machine (e.g., a jet engine), an animal (e.g., a dog), a nature object (e.g., a waterfall), etc. A sound generated by an object may overlap with a scope of background sounds. An object's sound may be distinguishable (e.g., more distinguishable than a mixed background sound) and/or the object may exist in the visual part of the video and may be seen at least in one video frame. For example, a song coming from a loudspeaker which is visually present in a video frame may be considered as a sound generated by an object, and a song added later (e.g., by a video producer) may be considered as a background sound (or background music). There may be more than one object that is capable of generating sounds. One or more than one object may be generating sounds at a time (e.g., solo, simultaneously, or overlapping). Each of the people and the objects may be an audio source and may have a separate audio signal (e.g., soundtracks).

In FIG. 3A, an example speaker icon 305a is shown on each of the first person 311, the second person 312, and the third person 313. For example, the three people may be having a conversation. Speaker icons may be located in proximity to corresponding people as shown in the video. One or more speaker icons 305a may appear, for example, based on operations of a computing device that includes the screen 301. The operations may be performed by one or more users. A user may include a person that may use and/or interact with the computing device (and/or with a user device associated with the computing device). For example, a user may be a person watching video content rendered by a video player on a television, a tablet, a smartphone, etc. The user's operations may include manual operations, audio operations, and/or any other forms of operations associated with the video display. For example, a user may press a button on a remote control device. A user may click on a virtual screen (e.g., on a smartphone). A user may hover a cursor over a target person or object on a video display. A user may speak a command to select audio related settings. Alternatively or additionally, one or more speaker icons 305a may appear based on automatic determination, for example, by a controller. For example, a detection of a user's reaction may lead to determination that the user may need manual control of one or more of the audio sources (e.g., people and/or objects). The determination may result in display of one or more speaker icons. One or more speaker icons 305a may appear on the screen for any person or object that has active audio signals (e.g., in a current scene). For example, the first person 311, the second person 312, and the third person 313 are having a conversation in the current scene. A speaker icon 305a may be shown for each of the persons 311-313. Alternatively or additionally, one or more speaker icons 305a may appear on the screen based on selection. For example, a user may select a first person 311 (e.g., from his/her controller, phone, cursor movement, audio command, etc.), and a speaker icon 305a may appear on the first person 311. Alternatively or additionally, a speaker icon may appear for any person or object that has separate audio signals (whether they are currently active or not).

In FIG. 3B, an example audio control box 306 is shown on one of the people (e.g., the second person 312). The audio control box 306 may comprise an interface that may allow a user to amplify (or increase), de-amplify (or decrease), or minimize (e.g., mute) selected audio signals (or sounds). In the example interface in FIG. 3B, the audio control box 306 may comprise a mute selection button and a volume bar. A user may adjust a volume of the sound of the selected person or object, for example, by using the volume bar. A user may mute a selected person or object, for example, by operating (e.g., pressing, clicking, checking) the mute selection button. Any other applicable interface may be used. For example, the mute selection button may be eliminated. A user may mute a selected person or object by using the volume bar (e.g., by dragging a dot on the volume bar to the far left). The audio control box 306 may appear, for example, based on a user's operations. The user's operations may include manual operations, audio operations, and/or any other forms of operations associated with selecting a person or object. For example, a user may hover a cursor over (or close to) the speaker icon 305a (e.g., on the second person 312), for example, after the speaker icon 305a appears. The audio control box 306 may appear, for example, based on the hovering, for the user to control the audio signals of the selected person (e.g., the second person 312). A person or an object may show an emphasizing (e.g., highlighting) effect, for example, based on the selection.

In FIG. 3C, an example interface with an operation to mute the second person 312 is shown. A user may move a cursor to the mute selection button and operate (e.g., press, click, check) the button. As described herein, other operations may be performed to mute a person or an object, for example, based on the interface. For example, a user may drag a dot on the volume bar to the far left. For example, a user may click on the speaker icon 305a to change the speaker icon into a mute icon 305b as shown in FIG. 3D.

FIG. 3D shows an example interface after the example operation in FIG. 3C. In FIG. 3D, the muted person (e.g., the second person 312) may show a muted icon 305b. A muted icon 305b may indicate that the audio signals of a corresponding person or object are inactive, ineffective, and/or removed. For example, the second person 312 may appear silent in FIG. 3D. The second person 312 may still appear to be talking from in frames of the video (e.g., his/her mouth may be moving). His/her sound may not be audible.

In FIG. 3E, the loudspeaker 320 may have active audio signals. A speaker icon 305a may appear on the loudspeaker 320, for example, based on manual operations and/or automatic determination, as described herein with respect to FIG. 3A. In FIG. 3F, an audio control box 306 may appear in a similar way as described herein with respect to FIG. 3B. Similarly, the loudspeaker 320 may show an emphasizing (e.g., highlighting) effect, for example, based on the selection.

In FIG. 3G, an example interface with an operation to adjust the volume of sound for the loudspeaker 320 is shown. A user may move a cursor to drag a dot on the volume bar to adjust the volume. For example, the user may drag the dot to the left to decrease the volume. Other operations may be performed to adjust the volume of sound for a person or an object, for example, based on the interface. For example, a user may click on a plus (e.g., “+”) or a minus (e.g., “−”) button to increase or decrease a volume of sound. For example, a user may input or select a number or level associated with a volume of sound. In the examples in FIG. 3G and FIG. 3H, an indication of a reduced sound from the loudspeaker 320 is shown. For example, the loudspeaker 320 may be outputting a song. The sound of the song may interfere with the voices of the people. A user may gain benefits such as hearing a clearer conversation from the video, reducing annoyance if he/she does not like the song, enjoying the song more without also hearing a louder conversation, etc. for example, based on adjusting (e.g., decreasing or increasing) the volume of sound for the loudspeaker 320. As shown in FIG. 3H, the emphasizing (e.g., highlighting) effect and/or the audio control box 306 may disappear, for example, based on the user's operations (e.g., move away the cursor and click elsewhere) and/or completion of the adjustment.

In FIG. 3I, an example interface with an operation to unmute the second person 312 is shown. A user may select (e.g., reselect) the second person 312, for example, by clicking on a muted icon 305b on the second person 312. An audio control box 306 may appear, for example, based on the user's clicking on the muted icon 305b. The audio control box 306 may comprise an interface that may allow a user to unmute a sound of a selected person or object. For example, the audio control box 306 may comprise an unmute selection button and a volume bar. FIG. 3J shows an example of the user operating (e.g., pressing, clicking, checking) the unmute selection button to unmute the second person 312. Any other applicable interfaces may be used to unmute a person or object. For example, the second person may be unmuted simply based on the user clicking on the muted icon 305b. FIG. 3K shows an example interface showing the second person unmuted. FIG. 3L shows an example of the video output reverted to a normal state (e.g., without any icons, emphasizing effect, or audio control box). The video may be reverted to a normal state, for example, based on a user's operations and/or completion of the adjustment. For example, the user may move away the cursor and click elsewhere. For example, the user may press a button (e.g., on a remote control device) to exit the volume operations. For example, all icons may disappear after a predetermined period of time (e.g., 5 seconds). The video output may continue with the changed audio signals. For example, in the video output of FIG. 3L, the loudspeaker 320 may play a song with a smaller volume, compared to the loudspeaker 320 in FIG. 3E. The user may gain a better (and/or a more personalized) experience watching the video.

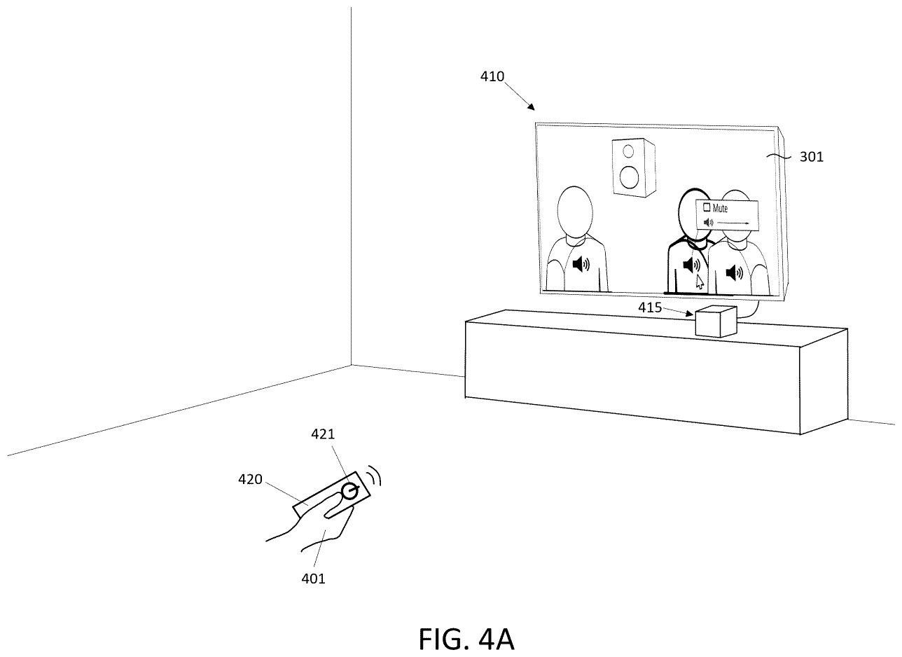

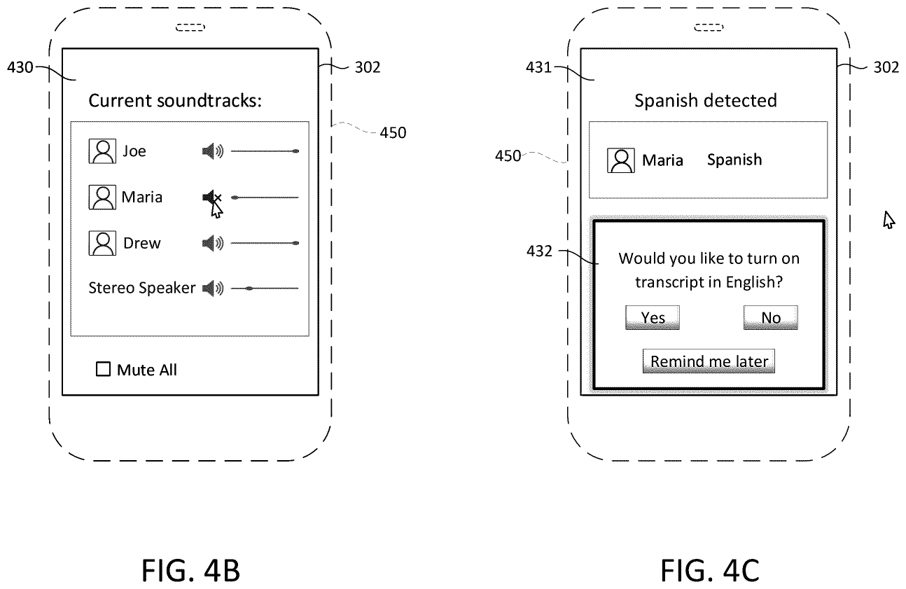

FIG. 4A shows an example application of manually selecting a character for audio control. A user device 410 may comprise a screen 301 (e.g., the screen 301 as shown in FIGS. 3A-3L). The user device 410 may be a display device with an associated computing device (e.g., the display device 112 and/or the gateway 111 and/or the other device 113 of FIG. 1, e.g., a television (TV)). The user device 410 may comprise and/or be associated with a premises computing device 415. For example, the computing device 415 may be a set-top box, a home automation device, etc. The user device 410 and/or the computing device 415 may be operable, for example, by a user. The user may operate and/or send control signals to the user device 410 and/or the computing device 415, for example, by using a remote control device 420. The remote control device 420 may be a dedicated device for remote controlling the user device 410 and/or the computing device 415. Alternatively, the remote control device 420 may be integrated with (e.g., as a function of) another device. For example, the remote control device 420 may be implemented as application software (APP) on a smart device (e.g., a smartphone, a tablet, a personal digital assistant (PDA), etc.). The remote control device 420 may be operated by hand, and/or based on gesture, facial (e.g., eye) movement, voice command, etc. In the example of FIG. 4A, a user's hand 401 may operate an input part (e.g., switch) 421 on the remote control device 420. The input part 421 may comprise a button (e.g., a push button), a touch panel, a directional controller, etc. The operation on the input part 421 may be converted into signals and sent to the user device 410 and/or the computing device 415. For example, a user may select a person on the screen 301 by moving a cursor over this person and pressing on a button on the remote control device 420. The person may be highlighted, and/or a speaker icon may appear over this person. An audio control box may appear, for example, based on a further operation of the user. An interface similar to that shown in and described with respect to FIG. 3B may appear on the screen 301, as indicated in FIG. 4A. The user may mute this person and/or to adjust the volume, for example, using the remote control device 420 and the interface on the screen 301. The operations described in connection with the devices in FIG. 4A could also or alternatively be performed using a smartphone (e.g., the mobile device(s) 125 of FIG. 1), a tablet, a gaming device, a virtual reality (VR) device, other multi-media player, and/or other computing device.

FIG. 4B shows another example interface for manual selection for audio control. The screen 302 in this example may be a touch screen (or touch panel) of a smart device 450 (e.g., a smartphone, a tablet, a personal digital assistant (PDA), etc.). In the example interface 430, one or more audio signals (e.g., soundtracks) may be indicated. The one or more audio signals may be, for example, current active audio signals (or soundtracks). The one or more audio signals may belong to one or more people and/or objects in the video being output (e.g., via the user device 410). For example, three people (e.g., Joe, Maria, and Drew) and an object (e.g., a stereo speaker) may have active audio signals. A user may manually control (amplify/increase volume, de-amplify/decrease volume, or remove/mute) the one or more audio signals, for example, based on the example interface 430. For example, as shown in FIG. 4B, the example interface 430 may comprise a speaker icon and a volume bar next to a corresponding icon and text (and/or other indicia) for each person or sound-emitting object. A user may mute a person or an object, for example, by clicking on the speaker icon. A user may adjust the volume of a person or an object, for example, by dragging the dot on the volume bar in the left or right direction. There may be an additional button to mute or unmute all audio signals. The example interface 430 may have any modifications and/or variations as applicable. For example, the layout of the names of people and sound-emitting objects may be different. For example, the speaker icons and the volume bars may be replaced by input boxes for numbers. For example, additional windows may appear to provide options for controlling the volumes. The example interface in FIG. 4B may enable a user to control the volume of a character or object not in the current video frames. For example, a user may hear a character talking in the background and may choose to mute this character via this example interface. The smart device 450 may be used as a remote control device for the video being output (e.g., via the user device 410). Also or alternatively, the smart device 450 may be used to output the video on its screen 302. For example, the interface 430 may be output over the video.

FIG. 4C shows an example interface for initiating language translation for a person (e.g., a character). The example interface 431 may indicate that Spanish language is detected in one of the audio signals (and/or transcripts). The example interface 431 may also show that the Spanish audio signals correspond to a person (e.g., Maria). The example interface 431 may appear automatically (e.g., based on settings and detection of the language) and/or based on a user's operation. For example, a user may provide his/her preference of language in the settings. The user may be notified of a different language (a language different from preferred language), for example, if active audio signals contain that different language. The user may be offered with an option to obtain translations for that different language. For example, a window 432 may pop up in the example interface 431, confirming with the user if a translated transcript is needed. In this example, the preferred language is English. The user may choose from options including positive (e.g., “yes”), negative (e.g., “no”), and delaying decision (e.g., “remind me later”). The confirmation (e.g., the window 432) may not be needed, for example, if translation is set to be automatic. Similarly to FIG. 4B, the smart device 450 may be used as a remote control device for the video being output (e.g., via the user device 410). Also or alternatively, the smart device 450 may be used to output the video on its screen 302. For example, the interface 431 may be output over the video.

FIG. 5 is a block diagram showing functional components associated with focused volume control. The remote control device 420 may comprise a switch 510, a memory 520, a processor 530, a communication interface (e.g., I/F) 540, a display/speaker 550, etc. The switch 510 may be configured to move a cursor and/or to select a person or an object. The switch 510 may be manually operated, and may be in the form of a push button, a touch panel, a directional controller, and/or any other form that may apply, for example, to the remote control device 420. For example, the switch 510 may be the input part 421 as described with respect to FIG. 4A. Alternatively or additionally, the switch 510 may operate via sound and/or gesture. Signals generated from the switch 510 may be transmitted via the communication interface 540. The memory 520 may be any memory such as random-access memory (RAM), flash memory, etc. Data may be communicated from the memory 520 and/or the processor 530 to an outside device (and vice versa), for example, via the communication interface 540. The communication interface 540 may comprise one or more of a transmitter, a receiver, a transceiver, a digital-to-analog (D/A) converter, an amplifier, etc. The communication interface 540 may be, for example, an infrared (IR) I/F, a wireless (e.g., radio frequency (RF)) I/F, etc. The communication interface 540 may support wireless communication protocols such as WIFI, BLUETOOTH, NFC, etc. Although not shown, the communication interface 540 may be configured to receive signals from the outside such as the computing device 415. For example, the signals may cause the display and/or speaker 550 to indicate an error via a visual display and/or sound. The processor 530 may be configured to control operations of the remote control device 420 (e.g., operations between the switch 510, the memory 520, the communication interface 540, and/or the display/speaker 550). For example, instructions for operations may be stored in the memory 520. The processor 530 may be any processors, microprocessors, microcontrollers, etc. that may apply to a remote control device. The display and/or speaker 550 may comprise a light, a screen (e.g., a light-emitting diodes (LED) display), a speaker, etc.

A user may operate the switch 510 to generate control signals for the computing device 415 and/or the user device 410. For example, the user may operate a toggle switch to move a cursor and select a character on a screen (e.g., screen 301) of the user device 410. The operations (e.g., moving, selecting) may generate electric signals. The processor 530 may convert the electric signals to specific commands. For example, moving the toggle up may generate an electric signal that may be interpreted by the processor 530 as a command to move the cursor up. For example, pressing a middle part (e.g., “OK” button) of the toggle switch may generate an electric signal that may correspond to a command of selecting a current character. Moreover, the user may operate the switch 510 to control the voice volume of the selected character. These commands may be sent (e.g., transmitted) as control signals, for example, to the computing device 415, via the communication interface (e.g., I/F) 540.

The computing device 415 may receive the control signals. The computing device 415 may implement the control signals, and/or send commands or messages to the video processing server 122, for example, based on the types of commands. For example, the computing device 415 may process a command and update the cursor position, for example, if the command is moving the cursor up. The computing device 415 may send a command to the video processing server 122, for example, if the command involves video processing at the server 122. For example, the command may be to decrease the volume of a selected character. The video processing server 122 may process a video (e.g., video stream) based on the received commands. For example, the video processing server 122 may identify audio signals for a character and de-amplify (e.g., decrease volume of) the audio signals, for example, for a next predetermined number of frames (e.g., 20 frames). The video processing server 122 may send the de-amplified audio signals to the computing device 415, for example, along with corresponding video frames. The computing device 415 may process the video and audio signals. For example, the computing device 415 may cache the video and audio signals, and/or may synchronize the video and audio signals in a video stream. The processed video and audio streams (e.g., video frames, soundtracks, etc.) may be sent to the user device 410 for output.

The computing device 415 may send a message to the video processing server 122, for example, to notify the video processing server 122 of an event. For example, the computing device 415 send a request to another server (e.g., the content server 106) for streaming a video. The computing device 415 may send a message to the video processing server 122, for example, based on the request. The video processing server 122 may start preparing for possible video processing, based on the message. For example, the computing device 415 may send a message to the video processing server 122, for example, if the computing device 415 is set to play a video from a local source (e.g., from a memory device associated with the computing device 415). In that example, the computing device 415 may also send content of the video (e.g., video frames and soundtracks) to the video processing server 122, as will be described herein.

The video processing server 122 may send one or more commands or messages to the computing device 415. For example, the video processing server 122 may send commands to update the firmware or software of the computing device 415. For example, the video processing server 122 may send a message to the computing device 415 to inform the computing device of an event (e.g., initializing preparation of a video).

The computing device 415 may send content to the video processing server 122. For example, the computing device 415 may have locally saved (e.g., downloaded, recorded, etc.) video content and/or may be connected to an outside device such as a USB device, a smartphone, a tablet, a laptop, a camera, an optical disc (e.g., DVD, Blu-ray discs), etc. The computing device 415 may send a local video stream to the video processing server 122 for processing, for example, based on commands received from the remote control device 420. For example, the computing device 415 may receive a command to mute one character in a local video stream. The computing device 415 may send the command and audio signals (and video signals) of the local video stream to the video processing server 122. The video processing server 122 may identify the audio signals of the character and may process to minimize the audio signals. If the audio signals of all characters are mixed, the video processing server 122 may separate the audio signals. The video processing server 122 may refer to the video signals in identifying the audio signals of a character. For example, the video processing server 122 may map the audio signals with the video signals, and/or may tag the signals with different names. The video processing server 122 may send processed content (e.g., processed audio signals) back to the computing device 415.

The computing device 415 may send control signals (e.g., device commands) to the user device 410, for example, if the control signals are associated with the user device 410. For example, the computing device 415 may receive control signals from the remote control device 420 to control the user device 410, for example, to turn ON/OFF the user device 410, to increase/decrease the device volume, etc. The computing device 415 may receive control signals directly from the user. Additionally or alternatively, the computing device 415 may generate control signals automatically, for example, based on detecting user behaviors, environmental noise, etc. The computing device 415 may send an user interface (UI) (e.g., user interfaces 430, 431 as shown in FIGS. 4B and 4C) to the user device 410 for output. The user interface may be generated by the computing device 415. Also or alternatively, the user interface may be generated by the video processing server 122, for example, based on commands and/or data from the remote control device 420 sent via the computing device 415 to the video processing server 122. The user interface generated by the video processing server 122 may be sent to the computing device 415 for output via the user device 410.

Examples as described in connection to FIG. 4A and FIG. 5 are not limiting, and alternate configurations may be implemented. For example, some or all functions described above (or elsewhere herein) as performed by the video processing server 122 may be performed by the computing device 415 and/or by the remote control device 420. The computing device 415 may be incorporated into and/or be a part of the user device 410. In addition to, or instead of, being received by the remote control device 420, user commands may be received by a computing device (e.g., for a home automation system). The computing device may be incorporated into and/or may communicate with the computing device 415 and/or the video processing server 122.

Alternatively or additionally, the computing device 415 may generate control signals (e.g., commands) automatically for the video processing server 122, for example, based on detecting user behaviors, environmental noise, etc. For example, the computing device 415 (e.g., part of a home automation system) may receive inputs from one or more sensors (e.g., one or more cameras 416 and/or one or more microphones 417). The computing device 415 may identify one or more users (e.g., people in a room) and/or their orientations towards a screen (e.g., screen 301) of a display device (e.g., user device 410). The computing device 415 may identify indications (or needs) to change the volume of a soundtrack, for example, based on actions and/or expressions of people, and/or environmental noise. For example, people may align their ears, move their heads with an expression such as “not hearing this”, and/or ask each other things such as “did you hear that”, “why is the volume so low”, “I can't hear a thing”, etc. These actions and/or expressions may indicate that people may have difficulty hearing a soundtrack (e.g., of a character) and that the volume of the soundtrack (e.g., of the character at the time) may need to be increased. Other factors including environmental noise may be used alone or combined with detected actions/expressions of people to determine the indication to change the volume of a soundtrack. For example, the computing device 415 may determine that the volume of a soundtrack needs to be increased, if volumes of environmental noise significantly increased. Additionally, timing and/or type of the environmental noise may be determined for more precise analysis and determination.

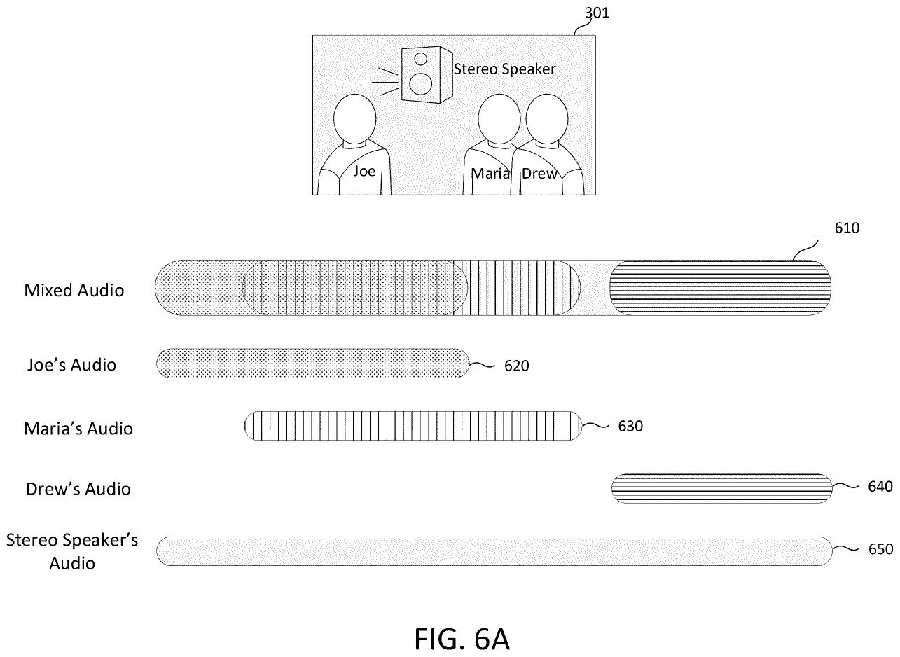

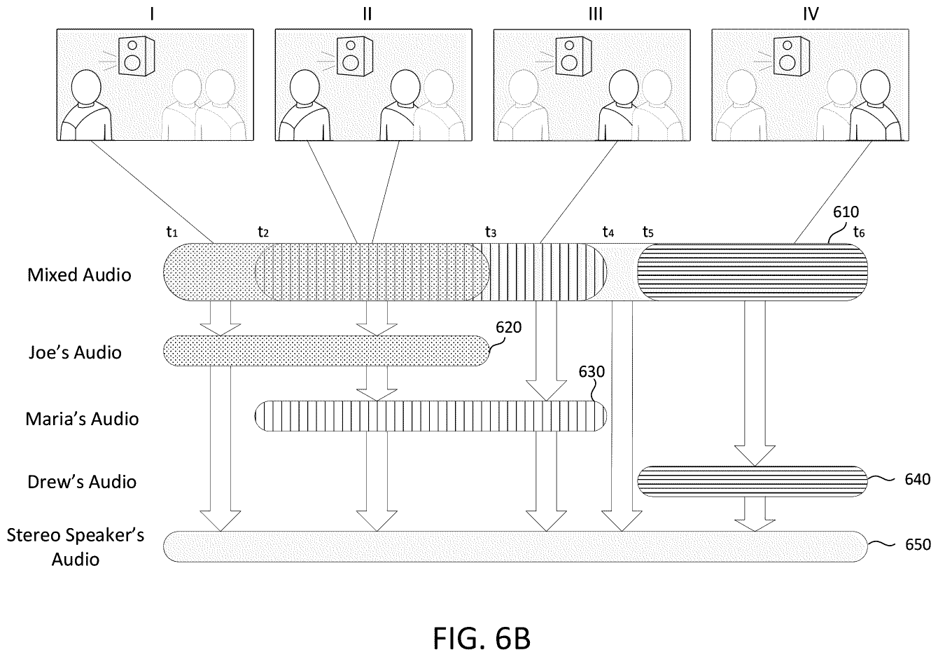

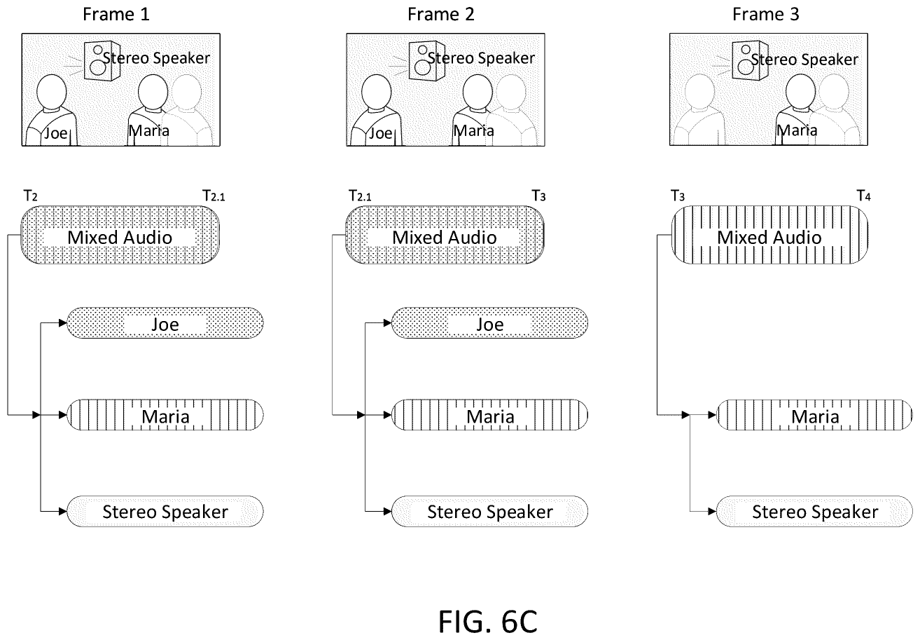

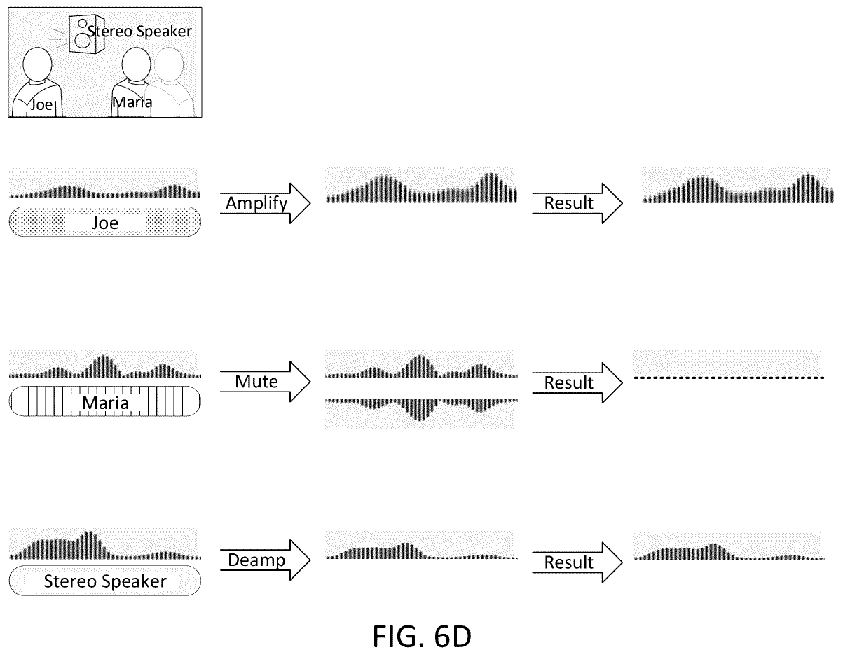

Mixed audio signals may be separated into individual audio signals corresponding to individual audio sources (e.g., characters and/or objects). Focused volume control (e.g., controlling the volume of an individual character or object) may be performed, for example, based on separated audio signals. FIG. 6A shows an example of mixed audio signals and separated audio signals (e.g., for a video segment). For convenience, the different audio signals associated with the persons and object shown in the example video of FIGS. 6A-6C are represented as elongated, rounded rectangles having different fill patterns to distinguish the different signals. The mixed audio signals (e.g., mixed audio 610) may be represented by a rounded rectangle with larger thickness compared to the individual audio signals, for example, to indicate overall bigger sound energy in the mixed audio signals. A video segment (e.g., as shown on the screen 301) as described herein may be an example segment of a video stream that may comprise corresponding audio signals. The video segment may comprise one or more video frames. In the example of FIG. 6A, a video segment may involve mixed audio signals 610. The mixed audio signals 610 may be a combination of audio signals of characters appearing in this video segment, for example, Joe, Maria, and Drew, as well as of objects appearing in this video segment, for example, the stereo speaker. The audio signals of these characters may overlap and/or may appear at different times. For example, Joe's audio (signals) 620 may appear first in this video segment (i.e., Joe talks first), and Maria's audio 630 may appear in an overlapping manner as Joe's audio (i.e., Maria starts talking while Joe is still talking). Maria may keep talking after Joe becomes quiet. Drew's audio 640 may appear last and may not overlap with Joe's or Maria's audio signals, which may mean that Drew starts talking after both Joe and Maria stop talking. The stereo speaker's audio 650 may appear throughout this video segment. For example, the stereo speaker may be playing a song that lasts the entire video segment.

FIG. 6B shows an example of separating mixed audio signals into individual audio signals. In the example of FIG. 6B, a video segment may comprise four video sub-segments I, II, III, and IV. Each video sub-segment may correspond to a different talking situation among the three characters. Note that this example is designed for the convenience of illustration. For example, each video sub-segment need not correspond to a different talking situation. Also for the convenience of illustration, in each sub-segment in FIG. 6B, the character or object that is making sounds is highlighted.

Video sub-segment I may correspond to a time period t₁ to t₂. In this time period, the mixed audio signals 610 may comprise Joe's audio 620 and the stereo speaker's audio 650. Video sub-segment II may correspond to a time period t₂ to t₃. In this time period, the mixed audio signals 610 may comprise Joe's audio 620, Maria's audio 630, and the stereo speaker's audio 650. Video sub-segment III may correspond to a time period t₃ to t₄. In this time period, the mixed audio signals 610 may comprise Maria's audio 630 and the stereo speaker's audio 650. Video sub-segment IV may correspond to a time period t₅ to t₆. In this time period, the mixed audio signals 610 may comprise Drew's audio 640 and the stereo speaker's audio 650. There may be other sub-segments in the video segment, for example, a sub-segment that corresponds to a time period t₄ to t₅ where the mixed audio signals 610 only comprise the stereo speaker's audio 650.

Mixed audio signals 610 may be separated into individual audio signals 620, 630, 640, and 650. Mixed audio signals 610 may comprise individual audio channels or signals that are provided with identifications (e.g., tagged). For example, a movie may be made with separate soundtracks for each character, using multitrack recording techniques. An individual microphone may be used for each actor to record their dialogues. Each microphone may be assigned to a separate channel, for example, on an audio recorder. Recorded soundtracks may remain separated during editing and sound mixing processes. Each soundtrack may be provided with (e.g., labeled, tagged) an identification (e.g., name, ID), for example, during the multitrack recording process, or as metadata after the recording. The resulted mixed audio signals may be a multi-channel audio file. The multi-channel audio file may be converted into multiple separate files, each file corresponding to a channel (i.e., an individual soundtrack). Each file may be tagged with an identification such as a name that is associated with a character's name. The separation of individual audio tracks from a multi-channel mixed audio track may be performed by available tools such as Audacity, Adobe Audition, DaVinci Resolve, etc.

Alternatively or additionally, mixed audio signals 610 may not comprise multiple individual channels. Mixed audio signals may be separated into individual audio signals, for example, through speaker diarization, speech separation, voice matching, etc. Speaker diarization may identify “who spoke when.” Mixed audio signals may be segmented based on speakers, for example, by using speaker diarization. Example tools for diarization may include pyannote-audio, Kaldi, Google Cloud Speech-to-Text, etc. Mixed audio signals (e.g., overlapping speech) may be separated into isolated audio signals, for example, by using speech separation. Example tools for speech separation may include deep learning models such as Conv-TasNet, SepFormer, open tools such as Speechbrain, etc. Separated audio tracks (e.g., voices) may be associated with specific people (e.g., characters) or objects. Unique features of each audio track may be extracted, for example, using speaker embeddings (e.g., x-vectors). Each audio track may be labelled as corresponding (e.g., mapped) to a particular character or object. For example, pre-labeled voice samples of characters may be used to train a model for voice matching. The mixed audio signals may be divided into manageable segments (e.g., 10-30 seconds), for example, for easier separation. The mixed audio signals may be separated, for example, on a frame by frame basis.

FIG. 6C shows examples of separating mixed audio signals of a frame into individual audio signals. The examples shown in FIG. 6C may comprise three consecutive video frames. Frame 1 may start at time T₂ and end at time T2.1. Frame 2 may start at time T2.1 and end at time T₃. Frame 3 may start at time T₃ and end at time T₄. Each frame may correspond to mixed audio signals or a mixed soundtrack. For example, the mixed audio signals of frame 1 may generate probable audio signals that are mapped to Joe, Maria, and Stereo speaker, respectively. For example, audio signals associated with Joe may be identified or determined based on vocal patterns (e.g., from pre-labeled voice samples of Joe). Joe in the frame 1 may be recognized using facial recognition and/or boundary detection, and may be labeled or tagged. The probable audio signals of Joe may map with Joe (e.g., boundary of Joe) in frame 1. Similar analysis may be performed on frame 2 and frame 3, and continuous mapping of the audio signals with the images in the frames may be achieved. A subsequent frame (e.g., frame 2) may be cached for a slight delay (e.g., 0.1 second or less), while the current frame (e.g., frame 1) is being processed, for continuity of video streaming. The length of the slight delay may depend on the processing capacity of the computing device (e.g., the video processing server 122). The frame being cached may include both audio and video data so that any lip-sync or frame sync issues may be avoided.

FIG. 6D shows examples of amplifying (e.g., increasing volume of), de-amplifying (e.g., decreasing volume of), and muting an individual soundtrack. An individual soundtrack may be a separated audio track of a person (e.g., a character) or an object. For example, in FIG. 6D, three individual soundtracks may correspond to voice of Joe, voice of Maria, and sound of a stereo speaker, respectively. An individual soundtrack may be controlled or adjusted, for example, by the video processing server 122. An individual soundtrack may be controlled or adjusted, for example, based on one or more control signals from the remote control device 420 received via an interface such as described herein. An individual soundtrack may be controlled or adjusted, for example, based on one or more commands from the computing device 415. The one or more commands may be generated based on the one or more control signals and/or based on detection of indications (or needs). For example, an individual soundtrack may be amplified (e.g., volume of a voice or a sound may be increased). An individual soundtrack may be de-amplified (e.g., volume of a voice or a sound may be decreased or reduced). An individual soundtrack may be minimized (e.g., a voice or a sound may be muted).

Individual soundtracks may be processed to achieve amplified, de-amplified, or muted effects. An individual soundtrack may be processed segment by segment. For example, a segment (or audio segment) may comprise multiple consecutive frames and a corresponding soundtrack. An individual soundtrack (e.g., Joe's soundtrack) for the segment may be amplified or de-amplified. For example, an amplification circuit (e.g., a variable gain circuit) may be used to amplify the individual soundtrack for the segment. For example, a de-amplification circuit (e.g., a variable attenuator) may be used to de-amplify the individual soundtrack for the segment. The amplified or de-amplified soundtrack for the segment may replace the original soundtrack for the segment. An individual soundtrack (e.g., Maria's soundtrack) may be muted. For example, an inverse soundtrack of the soundtrack for the segment may be generated (e.g., by using an inverse linear predictive coding (LPC) filter). The inverse soundtrack may be overlaid onto the original soundtrack. The resulted combination of soundtracks may appear muted, as shown in FIG. 6D.

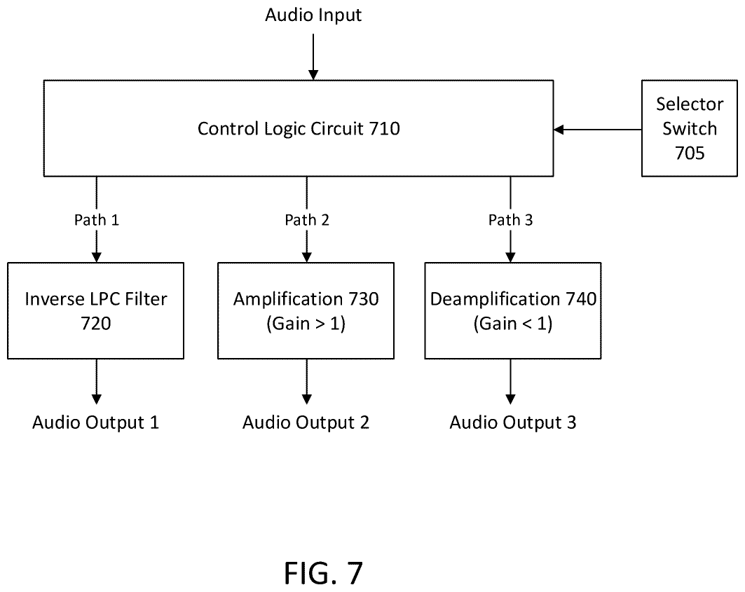

FIG. 7 is a block diagram showing circuit elements for amplifying, de-amplifying, and muting an individual soundtrack. An audio input may be provided to a control logic circuit 710. A selector switch 705 may be used with the control logic circuit 710 to select a path for processing the audio input. For example, there may be three paths: Path 1, Path 2, and Path 3. For example, path 1 may comprise an inverse LPC filter 720. An audio output 1 may be generated via path 1. The inverse LPC filter 720 may be used for generating inverse audio signals of the audio input. The audio output 1 may be overlaid on the original audio input, which may result in a muted soundtrack. Path 2 may comprise an amplification circuit 730. The amplification circuit 730 may be used for amplifying the audio input. An audio output 2 may be amplified audio signals. The audio output 2 may replace the original audio input, which may result in an amplified soundtrack. Path 3 may comprise a de-amplification circuit 740. The de-amplification circuit 740 may be used for de-amplifying the audio input. An audio output 3 may be de-amplified audio signals. The audio output 3 may replace the original audio input, which may result in a de-amplified soundtrack. The selector switch 705 may select a path, for example, based on the one or more commands, as described herein. The example in FIG. 7 is not limiting and may be modified or replaced by any other circuits that may achieve the same functions.

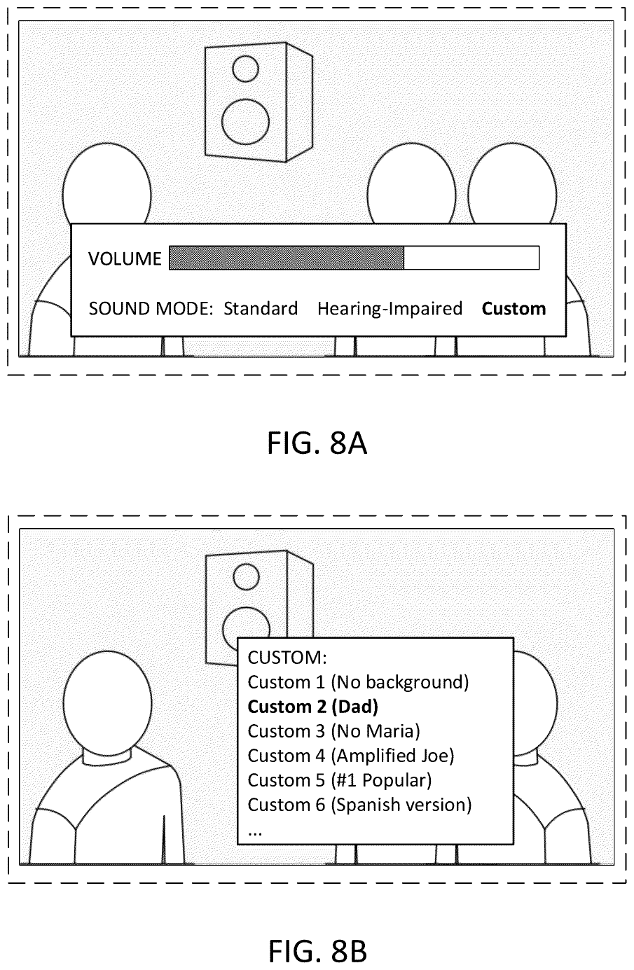

FIG. 8A shows an example interface for general volume control and audio modes. The example interface may be an interface (e.g., a screen) of any device, such as a television, a monitor, a smartphone, a tablet, etc. In the example of FIG. 8A, a box may appear, displaying a volume bar and a plurality of audio modes. A user may move the volume bar to adjust the volume level of the sound of the device. The plurality of audio modes may comprise different soundtracks that have been saved or obtained from one or more media sources. For example, the plurality of audio modes may comprise Standard, Hearing-Impaired, and Custom. The Standard mode may comprise the default soundtrack such as one that is in an DVD. The Hearing-Impaired mode may comprise a soundtrack that is configured for hearing-impaired people. Hearing-impaired people may wear hearing aids. A hearing aid is an electronic device that amplifies sounds coming into ears so that a hearing-impaired person may hear better. A hearing aid may amplify every sound, including high-volume sounds. For example, an explosion sound from a video (e.g., a movie) may be amplified and may cause discomfort for the person wearing a hearing aid. The hearing-impaired mode may comprise a soundtrack that de-amplifies high-volume sounds and/or amplifies low-volume sounds, so that a hearing-impaired person wearing a hearing aid may hear every sound of the soundtrack (e.g., clearly) without hearing any sound that exceeds a threshold of tolerance. The hearing-impaired mode may be produced along with the standard mode. For example, a media company make provide two versions of soundtracks (e.g., standard, hearing-impaired) for a video product. Alternatively or additionally, a hearing-impaired person may adjust the volume levels of individual audio signals as he/she watches a video (e.g., as described with respect to FIGS. 3A to 4C). For example, the hearing-impaired person may request muting a loud music from a stereo speaker, and/or amplifying Joe's voice. The adjusted audio signals may be saved (e.g., as an audio mode), for example, in a memory device associated with the video processing sever 122. The saved audio signals or soundtrack may be selected for future use and/or may be shared with others. For example, saved audio signals may be automatically used (or applied) the next time a same video is played. For example, other users may be able to download a soundtrack for hearing-impaired people, for example, from a shared internet folder. Also or alternatively, data from the adjusted audio signals (e.g., actions of change to the audio signals) may be saved (e.g., as an audio mode). The saved data may be used to automatically adjust (or control) the audio components (e.g., volumes) (e.g., as a roadmap), for example, if another person (e.g., a hearing-impaired person) may listen to the audio with the selected audio mode. The other person may choose this audio mode or apply the save data, for example, based on feedback from others (e.g., crowd-sourced feedback, ranking, etc.). The Custom mode may comprise any other soundtrack that is customized for one or more users.

FIG. 8B shows an example interface for custom audio modes. A user may click on the text Custom in the example interface in FIG. 8A, and an interface like the one shown in FIG. 8B may appear. The example interface in FIG. 8B shows examples of custom audio modes. For example, Custom 1 may comprise a soundtrack with background sounds (e.g., background music, background noise, etc.) removed. For example, a user might want to focus on listening to conversations and might not want any interference from background sounds. Custom 2 may comprise a soundtrack customized for Dad (e.g., a user of the device). Custom 2 might have been created by a dad in a family when he was watching this video. For example, this dad might have hearing issues and/or may have unique preferences. Custom 3 may comprise a soundtrack with no audio signals for the character Maria. For example, a user might dislike Maria's voice and prefer not hearing her talk (e.g., just watching subtitles instead). Custom 4 may comprise a soundtrack with amplified voice of Joe. For example, a user might find it hard to hear Joe and/or especially like Joe, and may want his voice to be louder. Custom 5 may comprise a soundtrack that is deemed popular, for example, among watchers of this video. For example, this customized audio mode may have been downloaded the most times. Custom 6 may comprise a soundtrack that has subtitles and/or all conversations in Spanish language. Audio modes such as Custom 5 and Custom 6 may be shared on the Internet, and may be retrieved and saved, for example, on the video processing sever 122. These customized audio modes, saved and available for selection, may free the users from the work of readjusting the voices and/or volume levels when they watch the same video a second time.

The interfaces as shown in FIGS. 8A and 8B are examples and may be implemented in any other forms, layouts, or formats. For example, the volume and the audio modes may be in separate interfaces. For example, a user may open a folder and select a saved audio file in the folder as the selected audio mode. For example, a search box may be provided, and a user may search across saved audio files and/or over the Internet for a specific audio mode. For example, the user may be able to search by name, author, description of the audio file or audio mode. For example, the interfaces may not be needed, and a user may control the volume and/or select an audio mode via voice commands.

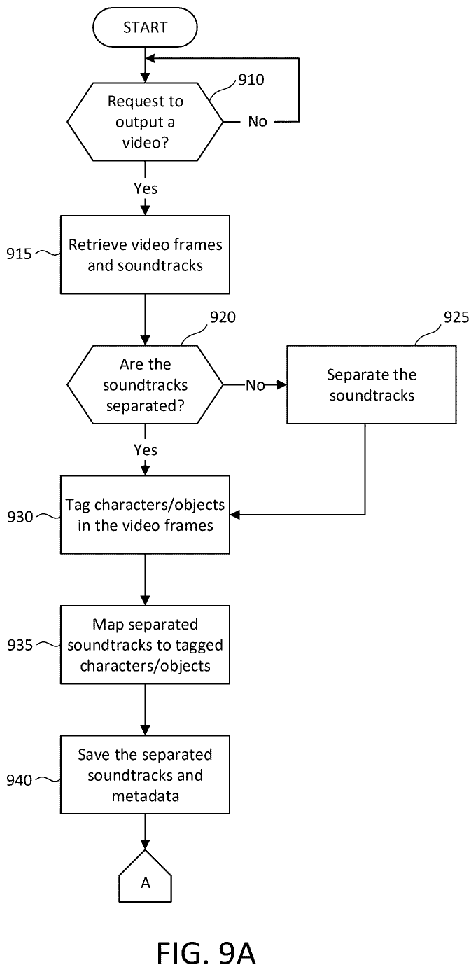

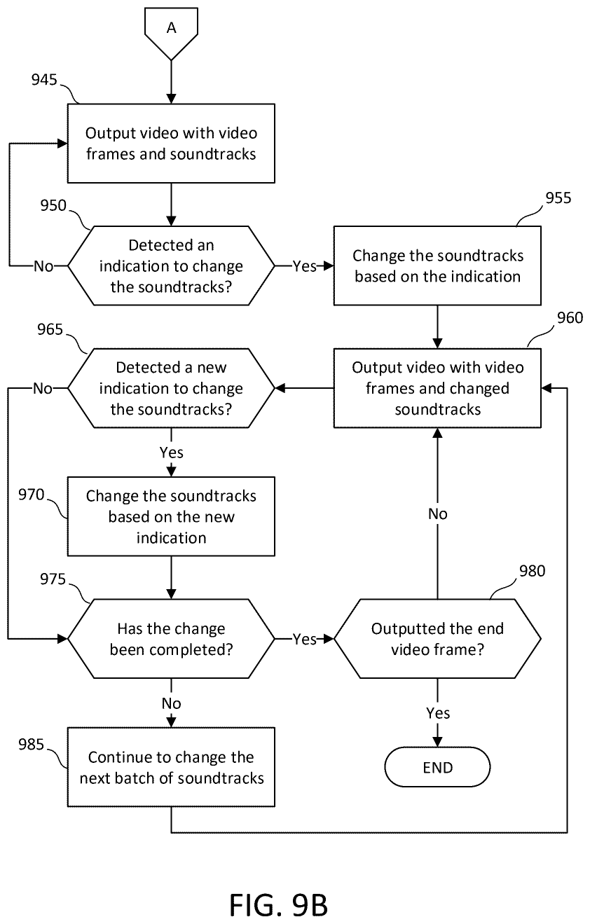

FIGS. 9A and 9B are a flow chart showing an example method for focused volume control for a video. For convenience, the method of FIGS. 9A and 9B is described in the context of an example in which steps are performed by the video processing server 122. However, one, some, or all steps of the example method may also or alternatively be performed by one or more other computing devices (e.g., the computing device 415 and/or other servers). One or more steps of the example method may be rearranged (e.g., performed in a different order and/or simultaneously), omitted, and/or otherwise modified, and/or other steps added.

In step 910, the video processing server 122 may determine if there is a request to output a video (or content item). For example, the video processing server 122 may receive, from the computing device 415, a message that video streaming is requested (e.g., with the content server 106). The video processing server 122 may alternatively receive a message that video streaming is requested from the content server 106. For example, the video processing server 122 may be integral with the content server 106 or may serve as an intermediate server between the content server 106 and the computing device 415. The video processing server 122 may receive, from the computing device 415, a command requesting a video. The computing device 415 may generate the command and/or message, for example, based on receiving a control signal from the remote control device 420. Also or alternatively, the video processing server 122 may receive a content item that comprises one or more video portions (e.g., video content, video-related files, video frames, etc.) and one or more audio portions (e.g., soundtracks) from the content server 106 and/or the computing device 415. The video processing server 122 may determine if there is a request to output a video, for example, based on the received message, command, and/or video content. If the video processing server 122 determines that there is no request to output a video, the video processing server 122 may keep checking for a request until one is received. If the video processing server 122 determines that there is a request to output a video, the video processing server 122 may perform step 915.

In step 915, the video processing server 122 may retrieve and/or receive a content item. The content item may comprise video and audio portions. For example, the video processing server 122 may retrieve video frames and soundtracks from the content server 106. The video processing server 122 may retrieve video frames and soundtracks from the computing device 415. The video processing server 122 may retrieve video frames and soundtracks from a local memory device associated with the video processing server 122, for example, if the local memory device stores the relevant video files. The video processing server 122 may receive (or accept, continue receiving) video frames and soundtracks from the computing device 415 and/or the content server 106, for example, if the computing device 415 and/or the content server 106 already started sending video content to the video processing server 122, for example, in step 910. The retrieved and/or received video content may be saved temporarily or permanently in a memory device associated with the video processing server 122, for example, the rewritable memory 203 (FIG. 2).

In step 920, the video processing server 122 may determine if the soundtracks (e.g., soundtracks retrieved/received in step 915) are separated or are separate soundtracks. The video processing server 122 may comprise programmed functions and/or may use available tools to determine (e.g., inspect) if the soundtracks are separated. For example, the video processing server 122 may verify the container format and/or metadata to see if they suggest separated soundtracks. For example, the video processing server 122 may comprise functions like those of a versatile media player or a multimedia editor that may indicate separate soundtracks. If the video processing server 122 determines that the soundtracks are not separated, in step 925, the video processing server 122 may separate the soundtracks. If the video processing server 122 determines that the soundtracks are separated, in step 930, the video processing server 122 may process the video frames.

In step 925, the video processing server 122 may separate the soundtracks, for example, in a way as described with respect to FIGS. 6A-6C. The video processing server 122 may separate the soundtracks by splitting channels, comparing signals (e.g., time, amplitude, and frequency differences between channels), and/or separating sources, for example, if the soundtracks are stereo or multi-track recordings. The video processing server 122 may separate the soundtracks by analyzing spatial information (e.g., time-of-arrival differences, phase differences, intensity variations, etc.), using beamforming algorithms, etc., for example, if the soundtracks were recorded by multiple microphones. Also or alternatively, the video processing server 122 may separate the soundtracks using blind source separation algorithms such as independent component analysis (ICA), non-negative matrix factorization (NMF). Probable separate soundtracks may be generated and saved as separate audio files.

In step 930, the video processing server 122 may tag audio sources such as persons (e.g., characters) and/or objects in the video frames. The video processing server 122 may tag a character and/or an object in a video frame, for example, via boundary detection. For example, the video processing server 122 may identify edges or contours of (e.g., a boundary box around) a character in the video frame, using available boundary detection tools (e.g., OpenCV). The video processing server 122 may annotate the detected character with a label or tag. For example, the video processing server 122 may add a tag (e.g., character name, ID) to the boundary box. Also or alternatively, the video processing server 122 may perform character recognition (e.g., facial recognition, body features, clothing patterns), for example, using a machine learning model. The video frames may be processed on a frame by frame basis. For example, a machine learning model may learn from continuous analysis of the last few frames. The processing may be automated for the video frames. Processed video frames may be saved with metadata (e.g., in a JSON file) including the boundary boxes, tags, etc.

In step 935, the video processing server 122 may map separated soundtracks to tagged audio sources (e.g., characters and/or objects) in the video frames. The video processing server 122 may extract time information and/or synchronization data associated with the separated soundtracks and the video frames, for example, based on timestamps. The time information may include start time, duration, etc. The video processing server 122 may analyze the data and/or may synchronize the soundtracks and the video frames, for example, based on timecodes and/or waveform analysis. The video processing server 122 may align the soundtracks and the frames on a frame by frame basis. A separate soundtrack may be mapped (e.g., matched, linked, etc.) to a tagged character (or object) in a video frame, for example, based on audio patterns, voice recognition (e.g., using automatic speech recognition (ASR)), speaker diarization, etc. For example, Joe's dialogue may be recognized using ASR and tagged as belonging to Joe, based on speaker diarization, which identifies his unique voice and/or speech pattern. For example, a stereo speaker's soundtrack may be recognized and tagged, for example, based on audio patterns of the stereo speaker. The separated soundtracks and the tagged characters (or objects) may be mapped, for example, based on tagged names (e.g., linking metadata). The mapping may be performed frame by frame. For example, for a video frame, a soundtrack named audioJoeframe000001 may be matched with a boundary box named videoJoeframe000001. The boundary box may correspond to a character Joe recognized in a video frame (e.g., frame000001), for example, by boundary detection.

In step 940, the video processing server 122 may save the separated soundtracks and metadata, for example, in a memory device associated with the video processing sever 122. In step 945 (FIG. 9B), the video processing server 122 may output the video with video frames and soundtracks, for example, to the computing device 415. The video frames and soundtracks may comprise at least the metadata as generated in steps 925, 930 and 935. The metadata may comprise mapped relationships between the video frames (e.g., boundary boxes in video frames) and the soundtracks (e.g., separated soundtracks).

In step 950 (FIG. 9B), the video processing server 122 may determine if an indication to change the soundtracks is detected. As described with respect to FIG. 5, the video processing server 122 may determine the indication based on manual operations of a user (e.g., via a user interface) and/or based on automatic detection and analysis. For example, a user may indicate a desire to change the volume of a character, for example, via the remote control device 420. The user interface may comprise a representation of one or more individual audio portions (e.g., soundtracks) associated with corresponding one or more individual audio sources (e.g., characters, objects, etc.). For example, the user interface may comprise a plurality of individually selectable elements (e.g., icons) corresponding to a plurality of audio sources (e.g., persons, objects) shown in the video, for example, as shown in FIGS. 3A-3L, 4A-4C. The indication to change (e.g., decrease, increase, mute, or otherwise adjust) an audio component (e.g., volume) of a portion of audio (or an individual audio portion) associated with an audio source (or an individual audio source) may be referred to as an input (e.g., a volume input). The video processing server 122 may determine the indication based on detected head movements and/or verbal expressions from users. For example, the video processing server 122 may determine to increase the volume of audio of a character displayed at the time of body actions of a user that suggest the user not hearing the audio. Alternatively, the indication may be determined by another computing device (e.g., the computing device 415) and a command may be generated based on the indication. The command may be sent to the video processing server 122 as an input. If the video processing server 122 determines that no indication to change the soundtracks is detected, the video processing server 122 may continue outputting the video. If the video processing server 122 determines that an indication to change the soundtracks is detected, in step 955, the video processing server 122 may change the soundtracks based on the indication. The video processing server 122 may pause the outputting of the video, for example, based on the determination.

In step 955, the video processing server 122 may generate an adjusted individual audio portion (e.g., a changed soundtrack), as described herein with respect to FIGS. 6D, 8A, and 8B. The video processing server 122 may amplify, de-amplify, or mute the soundtracks using corresponding circuits. For example, the video processing server 122 may replace an original soundtrack with an amplified or de-amplified soundtrack. For example, the video processing server 122 may create a muted soundtrack by overlaying an inverse soundtrack on an original soundtrack. Also or additionally, the video processing server 122 may select an audio mode based on the indication. For example, a user may select an audio mode to be played. For example, the video processing server 122 may determine to play an audio mode (e.g., Amplified Joe) based on user's command of increasing the volume of Joe.

In step 960, the video processing server 122 may output the video with video frames and changed soundtracks. For example, the changed soundtracks may be merged and aligned (e.g., stitched) with corresponding video frames. Delay due to audio processing may be measured and timeline may be adjusted to compensate for the delay. For example, the changed soundtracks may be outputted selectively on different devices. For example, soundtracks suitable for hearing-impaired people may be displayed via their hearing aids. For example, a changed soundtrack for user A may be different from a changed soundtrack for user B, and may be outputted via different devices (e.g., headphones, earbuds, etc.).

In step 965, the video processing server 122 may determine if a new indication to change the soundtracks is detected. This step is similar to step 950 and will not be described in detail herein. If the video processing server 122 determines that a new indication to change the soundtracks is detected, in step 970, the video processing server 122 may change the soundtracks based on the new indication. Step 970 is similar to step 955 and will not be described in detail herein. If the video processing server 122 determines that no new indication to change is detected, in step 975, the video processing server 122 may determine if the change in step 955 has been completed. If the video processing server 122 determines that the change in step 955 has been completed, in step 980, the video processing server 122 may further determine if an end video frame has been outputted. If the video processing server 122 determines that an end video frame has been outputted, no more action may be needed. If the video processing server 122 determines that an end video frame has not been outputted, in step 960, the video processing server 122 may continue outputting the video. If the video processing server 122 determines that the change in step 955 has not been completed, in step 985, the video processing server 122 may continue to change the next batch of soundtracks.

Although examples are described above, features and/or steps of those examples may be combined, divided, omitted, rearranged, revised, and/or augmented in any desired manner. Various alterations, modifications, and improvements will readily occur to those skilled in the art. Such alterations, modifications, and improvements are intended to be part of this description, though not expressly stated herein, and are intended to be within the spirit and scope of the disclosure. For example, besides the volume of a voice, pitch, accent, language, and/or any other parameter of the voice may be changed. For example, although the specification focuses on videos, the disclosure may be used for all kinds of one-way streaming. For example, the example interfaces may be in any form, design, layout and may be in any device (e.g., different from the display device). Accordingly, the foregoing description is by way of example only, and is not limiting.

1. A method comprising:
receiving a content item that has video and audio portions, wherein the audio portion comprises a plurality of individual audio portions associated with corresponding individual audio sources;
identifying one or more of the plurality of individual audio portions for an interface;
presenting the interface, wherein the interface comprises a representation of the one or more of the individual audio portions;
receiving an input to adjust an audio component associated with an individual audio portion; and
outputting the content item, wherein the audio portion comprises an adjusted individual audio portion.

2. The method of claim 1, wherein the received input to adjust comprises an input to change volume, and wherein the adjusted individual audio portion comprises a changed volume.

3. The method of claim 1, wherein the received input to adjust comprises an input to mute volume, and wherein the adjusted individual audio portion comprises a muted volume.

4. The method of claim 1, wherein the content item comprises one or more of a movie, a television show, an educational course, a promotional video, a sports program, a recorded art performance, a recorded gameplay, a recorded interview, or a virtual tour.

5. The method of claim 1, wherein the individual audio sources comprise a plurality of persons.

6. The method of claim 1, wherein the individual audio sources comprise one or more persons and one or more objects.

7. The method of claim 1, wherein the input indicates a first individual audio source, for which volume of a corresponding individual audio portion is to be reduced, and a second individual audio source for which volume of a corresponding individual audio portion is to be increased.

8. The method of claim 1, wherein the presenting the interface further comprises:
presenting the interface during outputting the content item.

9. The method of claim 1, wherein the video portion shows one or more of the individual audio sources, and the presenting the interface further comprises:
presenting the interface based on an individual audio source of the one or more of the individual audio sources being selected within a corresponding boundary of the selected individual audio source.

10. The method of claim 1, wherein the video portion shows one or more of the individual audio sources, and the representation of the one or more of the individual audio portions is located in proximity to the one or more of the individual audio sources as shown in the video portion.

11. The method of claim 1, further comprising:
generating, based on the input, the adjusted individual audio portion, wherein the outputting comprises replacing the individual audio portion with the adjusted individual audio portion.

12. The method of claim 1, further comprising:
saving, based on the received input, an audio mode comprising indication of one or more individual audio sources and of audio component adjustment associated with the one or more individual audio sources.

13. A method comprising:
presenting, during output of a content item that has a video portion and an audio portion that comprises a plurality of individual audio portions associated with corresponding individual audio sources, an interface that comprises a representation of one or more of the plurality of individual audio portions;
receiving, via the interface, an input to adjust an audio component associated with an individual audio portion represented in the interface;
generating, based on the input and during a pausing of the output of the content item, an adjusted individual audio portion; and
resuming output, of the content item, with the adjusted individual audio portion.

14. The method of claim 13, wherein the received input to adjust comprises an input to change volume, and wherein the adjusted individual audio portion comprises a changed volume.

15. The method of claim 13, further comprising:
receiving, based on one or more body actions of a user watching the content item, one or more second inputs.

16. The method of claim 13, wherein the input indicates one of a volume increase or a volume decrease, and wherein the resuming output comprises resuming output with the adjusted individual audio portion instead of the individual audio portion.

17. The method of claim 13, wherein the input indicates a volume mute, wherein the adjusted individual audio portion comprises an inverse of the individual audio portion, and wherein the resuming output comprises resuming output with the adjusted individual audio portion and the individual audio portion.

18. A method comprising:
outputting a content item that has video and audio portions, wherein the audio portion comprises a plurality of individual audio portions associated with corresponding individual audio sources;
receiving one or more inputs to adjust one or more audio components associated with one or more of the plurality of individual audio portions;
saving, based on the received one or more inputs, an audio mode comprising indication of one or more of the individual audio sources and of one or more audio component adjustments associated with the one or more of the individual audio sources;
receiving a selection of the audio mode; and
outputting the content item, wherein the audio portion comprises one or more adjusted individual audio portions based on the audio mode.

19. The method of claim 18, wherein the saving comprises saving:
an indication of a first individual audio source, of the one or more individual audio sources, for which a corresponding audio portion for the content item is to be output at a reduced volume, and
an indication of a second individual audio source, of the one or more individual audio sources, for which a corresponding audio portion for the content item is to be output at an increased volume.

20. The method of claim 18, wherein the individual audio sources comprise one or more persons and one or more objects.
